(19) United States
(12) Patent Application Publication
(10) Pub. No.: US 2011/0049269 A1
(43) Pub. Date: Mar. 3, 2011

(54) Fluid Dispensing Nozzle Structure

(76) Inventor: Yen-Liang CHIEN, Taipei (TW)

(21) Appl. No.: 12/624,575

(22) Filed: Nov. 24, 2009

Related U.S. Application Data
(63) Continuation-in-part of application No. 12/547,552, filed on Aug. 26, 2009.

(51) Int. Cl. B05B 1/26

(52) U.S. Cl. 239/498; 239/499

(57) ABSTRACT

An improved fluid dispensing nozzle structure is disclosed. The improved fluid dispensing nozzle structure of the present invention comprises a spout portion, an L-shape tubular portion and an Anti-Splashing Cap. A retaining portion is disposed at the front end of the spout portion and is in fluid communication with a path located in the spout portion. The L-shape tubular portion may be connected with the spout portion through the engagement between a first (connective) opening and the retaining portion. A second opening is disposed on the distal end of the L-shape tubular portion. The Anti-Splashing Cap may be fixedly connected with the L-shape tubular portion at the second opening.

### CROSS REFERENCES RELATED TO THE APPLICATION

This application is a continuation-in-part of U.S. patent application Ser. No. 12/547,552, filed on Aug. 26, 2009.

### BACKGROUND OF THE INVENTION

1. Field of the Invention

The invention generally relates to an improved fluid dispensing nozzle structure.

More particularly, the invention relates to an improved fluid dispensing nozzle structure that can substantially reduce the flow and the flowing speed to avoid splashing during operation.

2. Description of the Prior Art

As of now, fluid dispensing spouts 1 have been widely used for liquid soup bottles and bottles holding other types of fluids (for example, condiments). These fluid dispensing spouts 1 are easy to use. A user only has to lightly press the top portion of the spout to dispense the content.

Though they are easy to use, they have a big drawback. If the content is thick or viscous enough, the content would come out slowly when the spout is pressed. However, if the content is not thick or viscous enough, the content would rush out swiftly and cause splash (as illustrated in FIG. 1).

From the above, we can see that the fluid dispensing spout of the prior art has at least a major disadvantage and needs to be improved.

To eliminate the disadvantage of the fluid dispensing spout of the prior art, the inventor has put a lot of effort into the subject and has successfully come up with the improved fluid dispensing nozzle structure of the present invention.

### SUMMARY OF THE INVENTION

An object of the present invention is to provide an improved fluid dispensing nozzle structure that can substantially reduce the flow and the flowing speed to avoid splash.

Another object of the present invention is to provide an improved fluid dispensing nozzle structure that is structurally simple, easy to use and easy to be disassembled.

To reach these objects, the improved fluid dispensing nozzle structure of the present invention is disclosed. The improved fluid dispensing nozzle structure of the present invention comprises a spout portion, an L-shape tubular portion and an Anti-Splashing Cap. A retaining portion is disposed at the front end of the spout portion and is in fluid communication with a path located in the spout portion. A first (connective) opening is disposed on the proximal end of the L-shape tubular portion, and a second opening is disposed on the distal end of the L-shape tubular portion. The L-shape tubular portion is connected with the spout portion through the engagement between the first (connective) opening and the retaining portion. Several flow regulating rib-like pieces are circularly disposed on the inner wall of the second opening. A threaded external surface is disposed on the outside of the second opening. A first flow reducing protrusion is disposed on the bending portion of the path. A threaded internal wall is disposed on the inside of the Anti-Splashing Cap. A second flow reducing protrusion is centrally disposed in the Anti-Splashing Cap. At least one outlet is disposed by the second flow reducing protrusion. The fluid may come out through the outlet. The two protrusions and can substantially reduce the flow and the flowing speed of the content; therefore, splash may be avoided.

These features and advantages of the present invention will be fully understood and appreciated from the following detailed description of the accompanying Drawings.

### BRIEF DESCRIPTION OF THE DRAWINGS

FIG. 1 is a side view illustrating a fluid dispensing spout of the prior art in use.

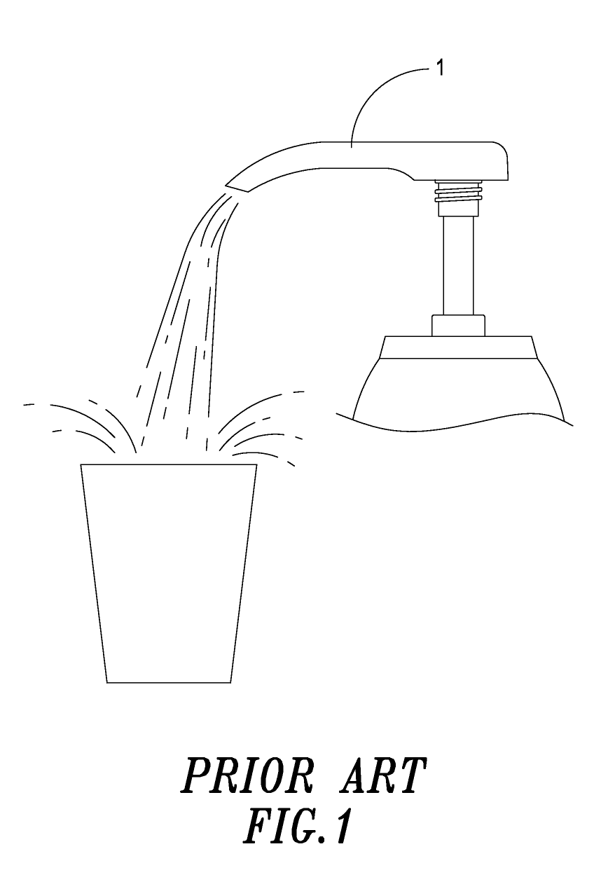

FIG. 2 is a partially exploded sectional view illustrating the improved fluid dispensing nozzle structure of the present invention.

FIG. 3 is a sectional view illustrating the improved fluid dispensing nozzle structure of the present invention in an assembled condition.

FIG. 4 is a bottom view of the L-shape tubular portion of the improved fluid dispensing nozzle structure of the present invention.

FIG. 5 is a sectional view illustrating the improved fluid dispensing nozzle structure of the present invention in use.

FIG. 6 is a sectional view illustrating another embodiment of the present invention.

### DESCRIPTION OF THE PREFERRED EMBODIMENT

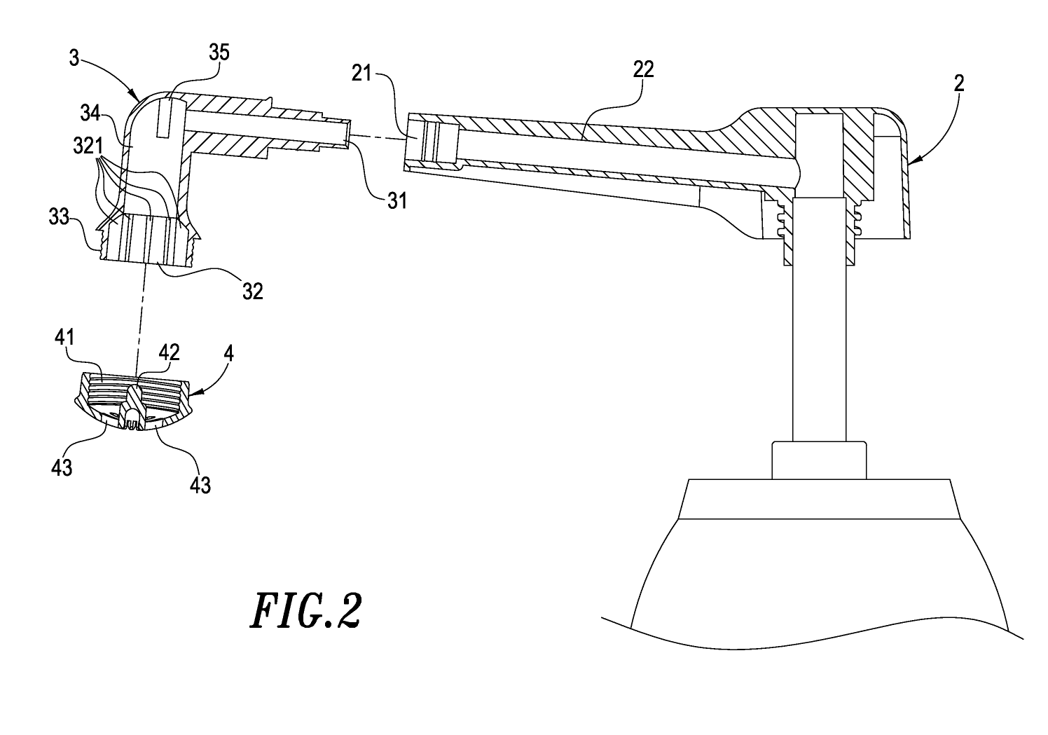

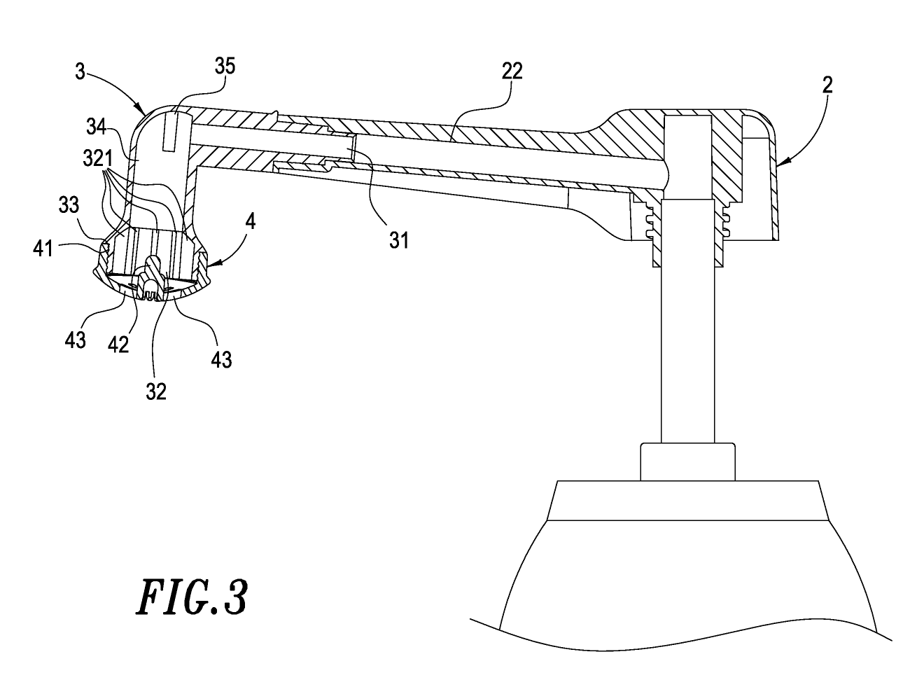

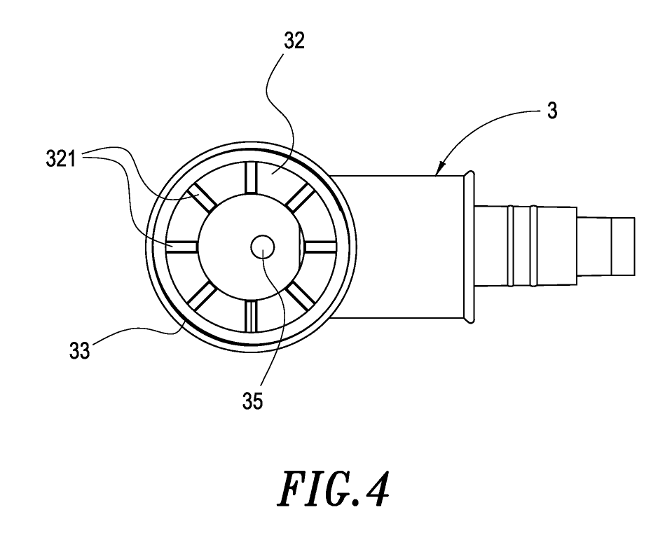

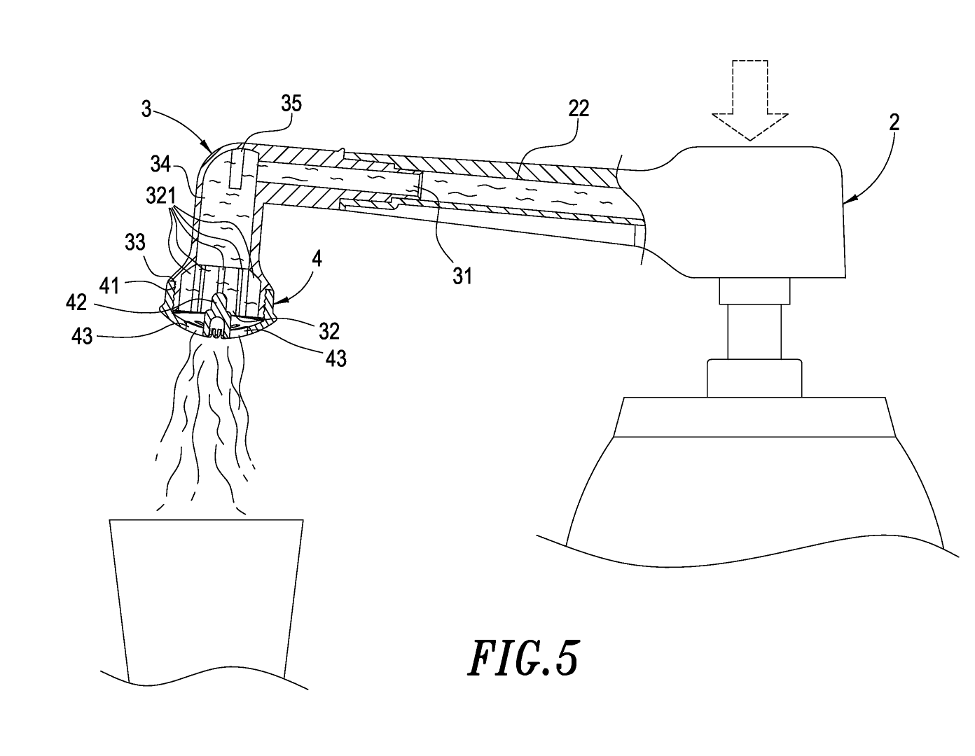

Please refer to FIGS. 2, 3 and 4, which illustrate the improved fluid dispensing nozzle structure of the present invention. The improved fluid dispensing nozzle structure of the present invention comprises a spout portion 2, an L-shape tubular portion 3 and an Anti-Splashing Cap 4. A retaining portion 21 is disposed at the front end of the spout portion 2 and is in fluid communication with a path 22 located in the spout portion 2. A first (connective) opening 31 is disposed on the proximal end of the L-shape tubular portion 3, and a second opening 32 is disposed on the distal end of the L-shape tubular portion 3. Several flow regulating rib-like pieces 321 are circularly disposed on the inner wall of the second opening 32. A threaded external surface 33 is disposed on the outside of the second opening 32. The first (connective) opening 31 and second opening 32 are in fluid communication with a path 34 located in the L-shape tubular portion 3. A first flow reducing protrusion 35 is disposed on the bending portion of the path 34. The L-shape tubular portion 3 may be connected with the spout portion 2 through the engagement between the first opening 31 and the retaining portion 21. A threaded internal wall 41 is disposed on the inside of the Anti-Splashing Cap 4. A second flow reducing protrusion 42 is centrally disposed in the Anti-Splashing Cap 4. At least one outlet 43 is disposed by the second flow reducing protrusion 42. The fluid may come out through the outlet 43. The Anti-Splashing Cap 4 may be fixedly connected with the L-shape tubular portion 3 through the engagement between the threaded internal wall 41 and the threaded external surface 33. In addition, FIG. 4 is a bottom view of the L-shape tubular portion 3 and clearly illustrates how the rib-like pieces 321 are disposed. Now, please refer to FIG. 5, which is a sectional view illustrating the improved fluid dispensing nozzle structure of the present invention in use. When a user presses the spout portion 2, the fluid would flow through the path 22 and the path 34. Now, the rib-like pieces 321, the first flow reducing protrusion 35 and second flow reducing protrusion 42 guide and reduce the flow so that the fluid may come out from the outlet 43 of the Anti-Splashing Cap 4. The two protrusions 35 and 42 can substantially reduce the flow and the flowing speed; therefore, splash may be avoided.

Because the unit 4 is fixedly connected with the L-shape tubular portion 3 through the engagement between the threaded internal wall 41 and the threaded external surface 33, we can separate the unit 4 from the L-shape tubular portion 3 easily if we want to clean up the unit 4.

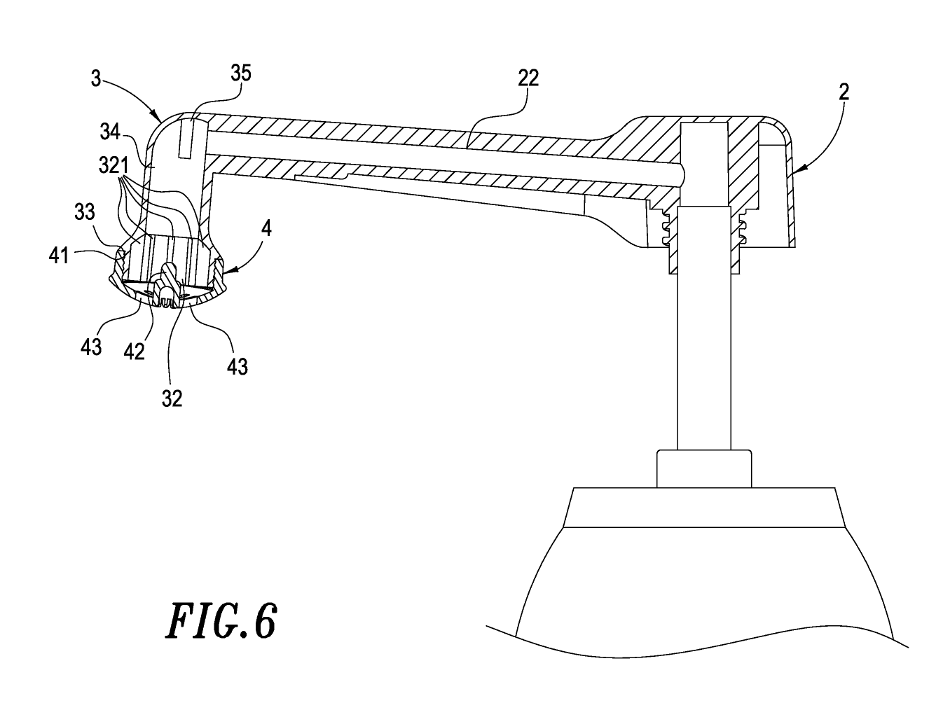

In another embodiment of the present invention, the spout portion 2 may be made into an integral part of the L-shape tubular portion 3. Please see FIG. 6.

In comparison to the prior art, the improved fluid dispensing nozzle structure of the present invention has the following advantages:

1. The improved fluid dispensing nozzle structure of the present invention can substantially reduce the flow and the flowing speed of the content; therefore, splash may be avoided.

2. The improved fluid dispensing nozzle structure of the present invention is structurally simple, easy to use and easy to be disassembled.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An improved fluid dispensing nozzle structure, comprising:
a spout portion, having a retaining portion, which is disposed at the front end of the spout portion and is in fluid communication with a path located in the spout portion;
an L-shape tubular portion, having a first (connective) opening, a second opening, several flow regulating rib-like pieces, a threaded external surface and a first flow reducing protrusion, wherein the flow regulating rib-like pieces are circularly disposed on the inner wall of the second opening, characterized in that the first (connective) opening is disposed on the proximal end of the L-shape tubular portion, that the second opening is disposed on the distal end of the L-shape tubular portion, and wherein the first opening and second opening are in fluid communication with a path located in the L-shape tubular portion, the L-shape tubular portion is connected with the spout portion through the engagement between the first (connective) opening and the retaining portion and the first flow reducing protrusion is disposed on the bending portion of the path; and
an Anti-Splashing Cap, having a second flow reducing protrusion and at least one outlet, wherein the second flow reducing protrusion is centrally disposed in the Anti-Splashing Cap and the outlet is disposed by the second flow reducing protrusion, characterized in that the Anti-Splashing Cap may be fixedly connected with the L-shape tubular portion at the second opening.

2. The improved fluid dispensing nozzle structure as in claim 1, wherein a threaded external surface is disposed on the outside of the second opening and a threaded internal wall is disposed on the inside of the Anti-Splashing Cap, characterized in that the Anti-Splashing Cap may be fixedly connected with the L-shape tubular portion through the engagement between the threaded internal wall and the threaded external surface.

3. The improved fluid dispensing nozzle structure as in claim 1, wherein, in another embodiment of the present invention, the spout portion may be made into an integral part of the L-shape tubular portion.
